(19) United States
(12) Patent Application Publication
(10) Pub. No.: US 2022/0290007 A1
(43) Pub. Date: Sep. 15, 2022

(54) FLOOR COATING COMPOSITION WITH ORGANOSILANE QUATERNARY AMMONIUM ION OR SALT THEREOF AND METHOD OF IMPARTING FLOOR BASE WITH ANTIMICROBIAL PROPERTIES WITH THE FLOOR COATING COMPOSITION

(71) Applicant: Parasol Medical, LLC, Buffalo Grove, IL (US)

(72) Inventor: Patrick E. Eddy, Allendale, MI (US)

(73) Assignee: Parasol Medical, LLC, Buffalo Grove, IL (US)

(21) Appl. No.: 17/692,665

(22) Filed: Mar. 11, 2022

Related U.S. Application Data
(60) Provisional application No. 63/160,619, filed on Mar. 12, 2021.

(51) Int. Cl. C09D 201/10; C09D 7/65

(52) U.S. Cl. CPC C09D 201/10; C09D 7/65; C09D 5/14

(57) ABSTRACT

A floor coating composition comprising: polymer particles, water, and an organosilane quaternary ammonium ion or salt thereof. The floor coating composition can further include a coalescing agent, such as diethylene glycol monoethyl ether, dipropylene glycol monomethyl ether, and isopropyl alcohol, a plasticizer, such as tributoxyethyl phosphate, and one or more waxes, such as oxidized polyethylene wax. The polymer particles can be particles of an acrylic copolymer or particles of a copolymer of styrene and an acrylic monomer. The floor coating composition can be applied to a floor base, which forms a film with the organosilane quaternary ammonium ion or salt thereof that imparts the film and thus the floor with residual antimicrobial properties.

### CROSS-REFERENCE TO RELATED APPLICATION

This application claims priority to and the benefit under 35 U.S.C. § 119(e) of U.S. Provisional Patent Application No. 63/160,619, entitled FLOOR COATING COMPOSITION WITH ORGANOSILANE QUATERNARY AMMONIUM ION OR SALT THEREOF AND METHOD OF IMPARTING FLOOR BASE WITH ANTIMICROBIAL PROPERTIES WITH THE FLOOR COATING COMPOSITION, filed on 12 Mar. 2021, the entire disclosure of which is incorporated herein by reference.

### BACKGROUND

Microbes, such as bacteria, spores, and viruses, can harm the health of a person. One person can transfer a microbe to another person through direct contact or indirectly, such as through the air or via a surface that the other person subsequently touches. The surface can be a floor. For example, one person can cough and thereby expel microbe-containing fluid onto the floor. Another person, such as a child, might touch the floor directly and transfer the microbe to the person's hand and, from the hand, enter into the body through the mouth.

Disinfecting the floor provides temporary benefit. The disinfection of the floor eliminates or removes microbes then existing on the floor. Thus, disinfection provides a sort of reset but does not serve to prevent a subsequent microbe transfer process from the one person to the other person. Thus, the problem of a floor harboring microbes that transfer to the other person still remains.

### SUMMARY

The present disclosure addresses that problem with a floor coating composition that includes polymer particles, water, and an organosilane quaternary ammonium ion or salt thereof. The floor coating composition can be applied to a floor base, such as vinyl, linoleum, stone, terrazzo, wood, and so on. As the water evaporates, the polymer particles coalesce into a film over the floor base. The organosilane quaternary ammonium ion or salt thereof remains dispersed throughout the film. The organosilane quaternary ammonium ion or salt thereof is an antimicrobial agent and destroys microbes that contact the molecule. The organosilane quaternary ammonium ion or salt thereof imparts such antimicrobial activity until the molecule is mechanically removed, such as through abrasion of the film. However, even then, abrasion of the film (such as would occur during normal foot traffic) reveals additional molecules of the organosilane quaternary ammonium ion or salt thereof, because such molecules were dispersed throughout the film. Thus, the floor coating composition retains residual antimicrobial activity until the film is fully removed.

In a first aspect of the present disclosure, a floor coating composition comprises: polymer particles, water, and an organosilane quaternary ammonium ion or salt thereof.

In a second aspect of the present disclosure, the first aspect further comprising a coalescing agent.

In a third aspect of the present disclosure, the second aspect, wherein the coalescing agent comprises one or more of diethylene glycol monoethyl ether and dipropylene glycol monomethyl ether.

In a fourth aspect of the present disclosure, any one of the first through third aspects further comprising a plasticizer.

In a fifth aspect of the present disclosure, the fourth aspect, wherein the plasticizer comprises tributoxyethyl phosphate.

In a sixth aspect of the present disclosure, any one of the first through fifth aspects further comprising one or more waxes.

In a seventh aspect of the present disclosure, the sixth aspect, wherein the one or more waxes comprise oxidized polyethylene wax.

In an eighth aspect of the present disclosure, any one of the first through seventh aspects, wherein the polymer particles comprise particles of an acrylic copolymer.

In a ninth aspect of the present disclosure, any one of the first through seventh aspects, wherein the polymer particles comprise particles of a copolymer of styrene and an acrylic monomer.

In a tenth aspect of the present disclosure, any one of the first through ninth aspects further comprising isopropyl alcohol.

In an eleventh aspect of the present disclosure, any one of the first through tenth aspects, wherein the organosilane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

In a twelfth aspect of the present disclosure, any one of the first through eleventh aspects, wherein the organosilane quaternary ammonium ion or salt thereof is 0.001% by weight to 50% by weight of the floor coating composition.

In a thirteenth aspect of the present disclosure, a floor comprises: a floor base and a film disposed on the floor base, the film comprising a polymer matrix and an organosilane quaternary ammonium ion or salt thereof dispersed throughout the polymer matrix.

In a fourteenth aspect of the present disclosure, the thirteenth aspect, wherein the film further comprises a plasticizer incorporated within the polymer matrix.

In a fifteenth aspect of the present disclosure, any one of the thirteenth through fourteenth aspects, wherein the film further comprises a wax dispersed throughout the polymer matrix.

In a sixteenth aspect of the present disclosure, any one of the thirteenth through fifteenth aspects, wherein the organosilane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

In a seventeenth aspect of the present disclosure, any one of the thirteenth through sixteenth aspects, wherein (i) the floor base comprises vinyl, asphalt, concrete, terrazzo, linoleum, rubber, stone, or wood and (ii) the floor base is visible through the film.

In an eighteenth aspect of the present disclosure, a method of imparting a floor base with antimicrobial properties comprises: applying a floor coating composition onto a floor base, the floor coating composition comprising polymer particles, water, and an organosilane quaternary ammonium ion or salt thereof.

In a nineteenth aspect of the present disclosure, the eighteenth aspect, wherein the floor coating composition further comprises a coalescing agent.

In a twentieth aspect of the present disclosure, any one of the eighteenth through nineteenth aspects, wherein (i) the organosilane quaternary ammonium ion or salt thereof is 0.001% by weight to 50% by weight of the floor coating composition and (ii) the organosilane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

### BRIEF DESCRIPTION OF THE FIGURES

In the figures:

FIG. 1 is a schematic illustration of a floor coating composition disposed within a container, illustrating the floor coating composition including polymer particles dispersed within a liquid and molecules of an organosilane quaternary ammonium ion or salt thereof both dispersed within the liquid and bound to the polymer particles;

FIG. 2 is a flow diagram of a method of imparting a floor base with antimicrobial properties, illustrating a step of applying the floor coating composition of FIG. 1 onto the floor base;

FIG. 3 is a perspective view of the floor coating composition of FIG. 1 being applied to the floor base, such as using a mop to transfer the floor coating composition from the container onto the floor base, and then mopping the floor coating composition over the floor base; and

FIG. 4 is a cross-sectional view of a floor after the floor coating composition of FIG. 1 is applied to the floor base of FIG. 3, illustrating the floor coating composition forming a film with a polymer matrix and the organosilane quaternary ammonium ion or salt thereof dispersed throughout the polymer matrix, with the organosilane quaternary ammonium ion or salt thereof available to impart antimicrobial activity at an initial surface of the film and, subsequently, after a portion of the film is worn away, at a new surface of the film.

### DETAILED DESCRIPTION

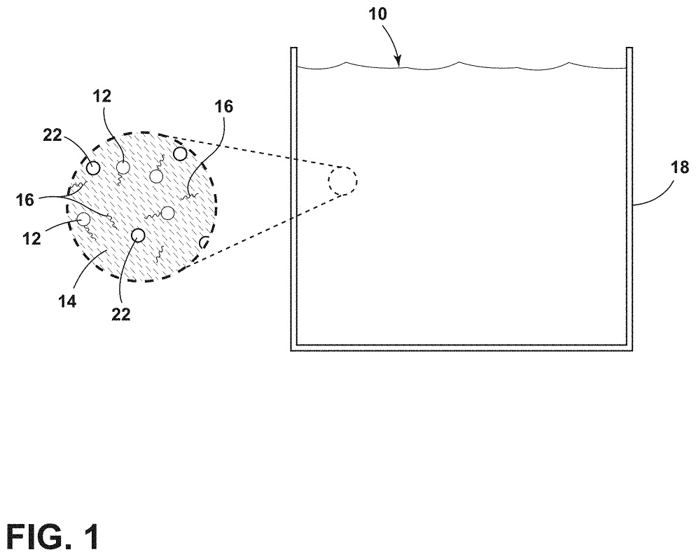

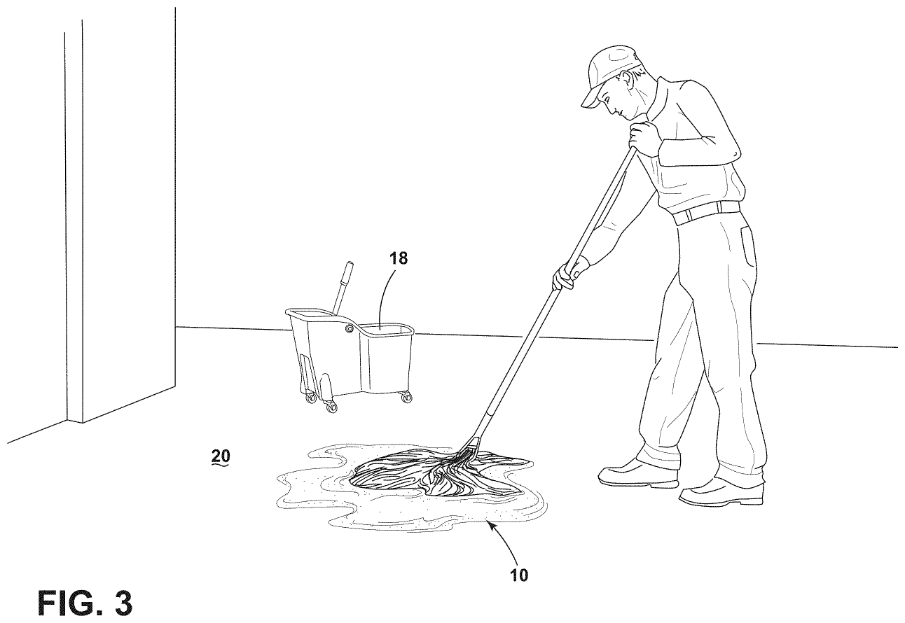

Referring now to FIG. 1, a floor coating composition 10 includes polymer particles 12 dispersed in a liquid 14 and molecules of an organosilane quaternary ammonium ion or salt thereof 16. The floor coating composition 10 can be held within a container 18, before being disposed onto a floor base 20 (see FIG. 3), as discussed below.

In embodiments, the polymer particles 12 of the floor coating composition 10 are or include particles of polymers and/or copolymers made from any of the following monomers: acrylic acid, methyl methacrylate, methyl acrylate, ethyl acrylate, ethyl methacrylate, acrylonitrile, styrene, butyl acrylate, 2-ehthylhexyl acrylate, butyl ethacrylate, dimethylaminoethyl methacylate, and methacrylic acid. In embodiments, the polymer particles 12 include particles of an acrylic copolymer. Examples of an acrylic copolymer include: (i) a copolymer of methyl methacrylate and methyl acrylate, (ii) a copolymer of methyl methacrylate, methyl acrylate, and dimethylaminoethyl methacrylate, (iii) a copolymer of methyl methacrylate and ethyl acrylate, (iv) a copolymer of methyl methacrylate and butyl acrylate, (v) a copolymer of methyl methacrylate and 2-ethylhexyl acrylate, (vi) a copolymer of ethyl methacrylate and methyl acrylate, (vii) a copolymer of ethyl methacrylate and ethyl acrylate, (viii) a copolymer of methyl methacrylate and butyl methacrylate, (ix) a copolymer of methacrylic acid, styrene, and acrylic acid, (x) a copolymer of methyl methacrylate, methyl acrylate, and methacrylic acid, (xi) a copolymer of methyl methacrylate, butyl acrylate, styrene, acrylonitrile, and methacrylic acid, and (xii) a copolymer of methyl methacrylate and methacrylic acid. In embodiments, the polymer particles 12 comprise particles of a copolymer of styrene and an acrylic monomer. Examples include, as mentioned above, (i) a copolymer of methacrylic acid, styrene, and acrylic acid, and (ii) a copolymer of methyl methacrylate, butyl acrylate, styrene, acrylonitrile, and methacrylic acid.

In embodiments, the polymer particles 12 include particles of cellulose acetate phthalate, cellulose acetate trimellitate, hydroxypropyl methylcellulose phthalate, hydroxypropyl methylcellulose acetate succinate, carboxymethyl ethyl cellulose, polyvinyl acetate phthalate, starch acetate phthalate, cellulose acetate succinate, styrene-maleic acid copolymer (SMA), polyvinylacetyl diethylamino acetate, poly(2-(dimethylamino)ethyl methacrylate), cellulose acetate diethylaminoacetate, carboxymethyl cellulose, methyl cellulose, hydroxyethyl cellulose, poly(vinyl alcohol), gelatin, polyvinylpyrrolidone, pyrrolidone/vinyl acetate copolymer, polyethylene glycol, hydroxypropyl methylcellulose, hydroxypropyl cellulose, polyvinylpyrrolidone-vinyl acetate copolymer, ethyl cellulose, cellulose acetate, polyvinyl acetate, and shellac.

In embodiments, the floor coating composition 10 further includes one or more waxes 22. The one or more waxes 22 can be discrete particles along with the polymer particles 12. In embodiments, the polymer particles 12 are 30 to 100 parts by weight, and the one or more waxes 22 are 0 to 70 parts by weight, where parts by weight combined of the polymer particles 12 and the one or more waxes 22 are 100 parts by weight. Examples of the one or more waxes 22 include high and low density polyethylene and polypropylene waxes, carnuba wax, candelilla wax, montan wax, a Fischer-Tropsch wax, microcrystalline wax, Chinese insect wax, ceresin, lanolin, ozokerite, cocoa butter, stearin, Japan wax, bayberry wax, beeswax, mutton tallow, oxidized polyethylene wax, polyethylene emulsions, polypropylene, waxes obtained by the hydrogenation of coconut oil or soybean oils, and paraffin wax. The one or more waxes 22 can be oxidized. The one or more waxes 22 can be in the form of a dispersion in water (so called wax “emulsion” despite the wax being solid in water at room temperature). In embodiments, the one or more waxes 22 include oxidized polyethylene wax emulsion.

In embodiments, the liquid 14 of the floor coating composition 10 includes a coalescing agent. Examples of the coalescing agent include a C1-C6 linear or branched alcohols, glycol ethers or ether alcohols, and mono alkyl ether alcohols. More specific examples include isopropyl alcohol, diethylene glycol C1-6 mono- or dialkyl ether (e.g., diethylene glycol monoethyl ether, diethylene glycol monomethyl ether, and diethylene glycol monobutyl ether), diethylene glycol ethyl ether, diethylene glycol butyl ether, dipropylene glycol methyl ether, tripropylene glycol ethyl ether, propylene glycol ethyl ether, glycol ether, triethylene glycol ethyl ether, EXANOL (2,2,4-Trimethyl-1,3-pentanediol monoisobutyrate), benzyl alcohol, and 3-methoxy-1-butanol, triethylene glycol, dipropylene glycol, tripropylene glycol, benzyl alcohol, and isophorone. In embodiments, the coalescing agent (and thus the liquid 14 of the floor coating composition 10) includes one or more of diethylene glycol monoethyl ether and dipropylene glycol monomethyl ether. In embodiments, the coalescing agent (and thus the liquid 14 of the floor coating composition 10) includes diethylene glycol monoethyl ether. In embodiments, the coalescing agent (and thus the liquid 14 of the floor coating composition 10) includes both diethylene glycol monoethyl ether and dipropylene glycol monomethyl ether.

In embodiments, the liquid 14 of the floor coating composition 10 includes a plasticizer.

Examples of plasticizers include caprolactam, benzyl butyl phthalate, dibutyl phthalate, dimethyl phthalate, benzyl 2-ethylhexyl phthalate, butyl cyclohexyl phthalate, diethylene glycol dibenzoate, dibenzyl sebacate, acetyltributylcitrate, butyl phthalyl butyl glycolate, tricresyl phosphate, triphenyl phosphate, tributyl phosphate, and tributyoxyethyl phosphate. In embodiments, the plasticizer is or includes tributyoxyethyl phosphate. In embodiments, the coalescing agent and the plasticizer are 3 to 75 parts by weight of the combined polymer particles 12 and one or more waxes 22 (which are a combined 100 parts by weight, as mentioned).

In embodiments, the liquid 14 of the floor coating composition 10 is or further includes water. In embodiments, water is included in an amount so that the total solids content (e.g., the polymer particles 12 and other solid components such as the one or more waxes 22) is 8% to 45% by weight of the floor coating composition 10.

In embodiments, the organosilane quaternary ammonium ion or salt thereof 16 of the floor coating composition 10 is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride. In embodiments, the organosilane quaternary ammonium ion or salt thereof 16 is 0.001% by weight to 50% by weight of the floor coating composition 10. In embodiments, the organosilane quaternary ammonium ion or salt thereof 16 is 0.001% by weight, 0.01% by weight, 0.10% by weight, 0.15% by weight, 0.20% by weight, 0.25% by weight, 0.5% by weight, 1% by weight, 2% by weight, 3% by weight, 4% by weight, 5% by weight, 6% by weight, 7% by weight, 8% by weight, 9% by weight, 10% by weight, or within any range bounded by any two of those values (e.g., 2% by weight to 9% by weight, 1% by weight to 5% by weight, etc.) of the floor coating composition 10.

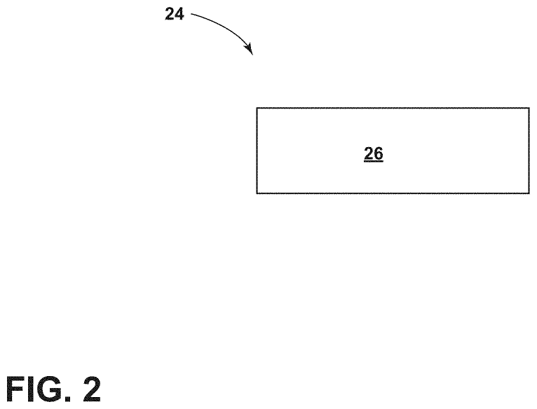

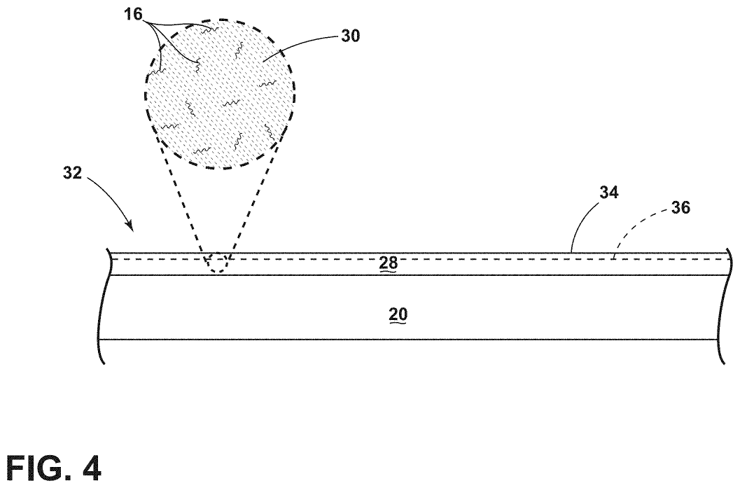

Referring now to FIGS. 2-4, a method 24 of imparting the floor base 20 with antimicrobial properties includes, at a step 26, applying the floor coating composition 10 onto the floor base 20. The floor coating composition 10 can be applied via spraying, mopping, broadcasting, and the like. The floor base 20 can be any type of flooring, such as vinyl, asphalt, concrete, terrazzo, linoleum, rubber, stone, or wood (sealed or unsealed).

The silane functional group of the organosilane quaternary ammonium ion or salt thereof 16 is reactive, and (without being bound by theory) likely reacts with and bonds to the polymer particles 12. The quaternary ammonium functional group remains free to act as an antimicrobial agent, as further discussed below. Other of the organosilane quaternary ammonium ion or salt thereof 16 may remain dissolved in the liquid 14.

As the floor coating composition 10 is applied to the floor base 20, the polymer particles 12 (some with the organosilane quaternary ammonium ion or salt thereof bound thereto) are relatively uniformly distributed over the floor base 20 because of the liquid 14 (including the water). The coalescing agent, if included in the floor coating composition 10, softens the polymer particles 12 and causes the polymer particles 12 to coalesce and form a film 28 with a polymer matrix 30 that is disposed on the floor base 20. The liquid 14, including the water and most or all of the coalescing agent, then evaporates. The plasticizer, if included in the floor coating composition 10, becomes incorporated into the polymer matrix 30, thereby lowering the glass transition temperature of the polymer matrix 30 and further aids in formation of the film 28. The lowered glass transition temperature can assist with subsequent burnishing operations. The one or more waxes 22, if present in the floor coating composition 10, also become part of the polymer matrix 30. The one or more waxes 22 may increase the ability of the film 28 to be repaired via buffing or burnishing, and increase the coefficient of friction of the film 28.

The result is a floor 32 with the floor base 20 and the film 28 disposed on the floor base 20. The film 28, as mentioned, includes the polymer matrix 30 but also includes the organosilane quaternary ammonium ion or salt thereof 16 dispersed throughout the polymer matrix 30, which imparts antimicrobial activity to the film 28 and thus the floor 32. The term “antimicrobial” as used herein means the ability of the compound composition or article to eliminate, remove, inactivate, kill, or reduce microorganisms, such as bacteria, viruses, fungi, molds, yeasts and spores.

Some of the organosilane quaternary ammonium ion or salt thereof 16 will be available at an initial surface 34 of the film 28. Without being bound by theory, it is believed that the organosilane quaternary ammonium ion or salt thereof 16 includes a positively charged nitrogen moiety and a long molecular chain extending therefrom. In the event that a microbe contacts the initial surface of the film 28, the positively charged organosilane quaternary ammonium ion or salt thereof 16 attracts the microbe. The long molecular chain ruptures the microbe thus destroying it. As mentioned, the organosilane quaternary ammonium ion or salt is covalently bound to the polymer matrix 30. Thus, the organosilane quaternary ammonium ion or salt remains, after destroying the microbe, ready to destroy another microbe. That mechanism is different and more residual than other mechanisms of antimicrobial activity that rely upon leaching of metal ions, such as ions of silver or copper. Eventually, enough of the metal will have leached so as to no longer impart antimicrobial properties.

In the event that the film 28 is wore down through foot traffic, buffering, or burnishing, and the initial surface 34 is gone but a new surface 36 is generated, fresh portions of the organosilane quaternary ammonium ion or salt thereof 16 that was dispersed throughout the polymer matrix 30 of the film 28 become present at the new surface 36 to continue to impart antimicrobial properties to the film 28. In embodiments, the film 28 is substantially clear such that the floor base 20 is visible through the film 28.

What is claimed is:

1. A floor coating composition comprising:
polymer particles;
water; and
an organosilane quaternary ammonium ion or salt thereof.

2. The floor coating composition of claim 1 further comprising:
a coalescing agent.

3. The floor coating composition of claim 2, wherein the coalescing agent comprises one or more of diethylene glycol monoethyl ether and dipropylene glycol monomethyl ether.

4. The floor coating composition of claim 1 further comprising:
a plasticizer.

5. The floor coating composition of claim 4, wherein the plasticizer comprises tributoxyethyl phosphate.

6. The floor coating composition of claim 1 further comprising:
one or more waxes.

7. The floor coating composition of claim 6, wherein
the one or more waxes comprise oxidized polyethylene wax.

8. The floor coating composition of claim 1, wherein
the polymer particles comprise particles of an acrylic copolymer.

9. The floor coating composition of claim 1, wherein
the polymer particles comprise particles of a copolymer of styrene and an acrylic monomer.

10. The floor coating composition of claim 1 further comprising:
isopropyl alcohol.

11. The floor coating composition of claim 1, wherein
the organosilane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

12. The floor coating composition of claim 1, wherein
the organosilane quaternary ammonium ion or salt thereof is 0.001% by weight to 50% by weight of the floor coating composition.

13. A floor comprising:
a floor base; and
a film disposed on the floor base, the film comprising a polymer matrix and an organosilane quaternary ammonium ion or salt thereof dispersed throughout the polymer matrix.

14. The floor of claim 13, wherein
the film further comprises a plasticizer incorporated within the polymer matrix.

15. The floor of claim 13, wherein
the film further comprises a wax dispersed throughout the polymer matrix.

16. The floor of claim 13, wherein
the organosilane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

17. The floor of claim 13, wherein
the floor base comprises vinyl, asphalt, concrete, terrazzo, linoleum, rubber, stone, or wood; and
the floor base is visible through the film.

18. A method of imparting a floor base with antimicrobial properties comprising:
applying a floor coating composition onto a floor base, the floor coating composition comprising polymer particles, water, and an organosilane quaternary ammonium ion or salt thereof.

19. The method of claim 18, wherein
the floor coating composition further comprises a coalescing agent.

20. The method of claim 18, wherein
the organosilane quaternary ammonium ion or salt thereof is 0.001% by weight to 50% by weight of the floor coating composition; and
the organosilane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.
